(19) United States
(12) Patent Application Publication
(10) Pub. No.: US 2021/0219699 A1
(43) Pub. Date: Jul. 22, 2021

(54) PERFECT HAIRLINER

(71) Applicant: CHAKA MUATA MISHOE, I, WEST ORANGE, NJ (US)

(72) Inventor: CHAKA MUATA MISHOE, I, WEST ORANGE, NJ (US)

(21) Appl. No.: 16/747,895

(22) Filed: Jan. 21, 2020

(51) Int. Cl. A45D 44/00; G01B 3/14; G01B 3/00; G01B 3/02

(52) U.S. Cl. CPC A45D 44/00; G01B 3/02; G01B 3/006; G01B 3/14

(57) ABSTRACT

The present invention provides a barber instrumentality useful for verifying, establishing and producing accurate, symmetrical hair lines and hair art designs. In particular, methods are provided herein for the use of the instrumentality wherein precise measurements can be taken to accurately verify, establish and produce symmetrical hair lines and hair art designs on face, forehead, scalp or neck.

### FIELD OF INVENTION

Said invention relates to an apparatus and methods for any hair practitioner, especially Barbers, to verify, establish and produce symmetry for all hair lines and hair art designs that are supposed to be symmetrical.

### BACKGROUND OF INVENTION

Inaccurate proportioned hair lines are a major concern in modern society. There are often situations when a barber finishes a haircut, in particular a hair line service and hands patron the mirror and patron would make mention that the hair line on one side of their face, forehead or neck is not even/symmetrical with the hair line on the other side of their face, forehead or neck; the practitioner may in fact, feel that it is even or symmetrical, leaving the client and the practitioner searching for a median of satisfaction based on personal subjection, which can lead to further undesirable results. Because of this, there is a need for an apparatus comprising methods that does more than just establish and aid in the production of symmetrical hair lines and hair art designs, but an apparatus that can also verify symmetry of hair lines and hair art designs when practitioner and patron's perceptions are not mutual.

### SUMMARY OF INVENTION

The present invention consists of a flexible, symmetrical, measuring apparatus and disclosed methods for verifying, establishing and producing symmetrical hairlines on face, forehead, neck or scalp. For the purposes of this invention, verifying is using apparatus and method to check for hair line symmetry after practitioner renders service; establishing is using apparatus and method to determine symmetrical accuracy for hair lines and hair art designs before service is rendered, to eliminate room for error; and producing is using tool of choice to shape/form symmetrical hair line or hair art designs that has already been established.

Apparatus is long enough to simultaneously contour to both sides of face, forehead or neck and scalp without practitioner having to transition oneself, apparatus or patron, and small enough to fit in barber sanitation jar; apparatus being Rectangular in shape; comprising a point of origin gauge, extending from one horizontal plane to the other. Each of the two planes has a graduated numbered symmetrical scale extending outwardly on the left and right side of point of origin gauge; one plane being scaled in macro measurements and the other plane being scaled in micro measurements for more precision. (Drawings and claims will further simplify)

Method to verify if the left and right side of a particular hair line is symmetrical; user holds apparatus horizontally; if necessary, rotate apparatus clockwise or counter-clockwise 180 degrees to choose desired scale; holding apparatus horizontally, align and center point of origin gauge over the Divine midpoint bone on face, forehead or neck (nasal bone, mandible vomer bone, spinal bone); while point of origin gauge stays centered with Divine midpoint bone (line of symmetry), user will flex apparatus until it touches portion of hair line to be verified for symmetrical accuracy; when touching read scales to the left and right side of point of origin gauge. If increments to the left side of point of origin gauge equals the amount of increments to the right side of point of origin gauge, then symmetrical accuracy is verified without practitioner having to transition oneself, apparatus or patron. (Drawings and claims will further simplify).

Method to establish and produce hair line symmetry; user holds apparatus horizontally; if necessary, rotate apparatus clockwise or counter-clockwise 180 degrees to choose desired incremented scale; user will hold apparatus horizontally and center point of origin gauge (middle of liner) over Divine midpoint bone on face, forehead or neck (mandible vomer bone, nasal bone, spinal bone); while point of origin gauge stays centered with Divine midpoint bone (line of symmetry), using one hand, simultaneously flex the left and right side of apparatus until it touches desired portion of hair line to be established for symmetrical accuracy; using other hand, dot desired portion of hair line where it meets desired symmetrical increments on apparatus with eyeliner pencil; using dots as a guide, produce hair line with tool of choice. (Drawings and claims will further simplify).

Method to establish and produce symmetrical placement for symmetrical hair art designs; user holds apparatus horizontally, if necessary, rotate apparatus clockwise or counter-clockwise 180 degrees to choose desired numerical incremented scaled plane; hold apparatus horizontally and place the point of origin gauge (middle of claimed apparatus) centered with midpoint of hair art design; while point of origin gauge stays centered with midpoint of hair art design flex the left and right side of flexible apparatus until laying flush on desired range of artwork; once landed on desired range of artwork, using other hand; use eyeliner pencil to dot range of artwork according to desired symmetrical numerical increments on apparatus; using dots as a guide; produce hair line with tool of choice. (Drawings and claims will further simplify).

### BRIEF DESCRIPTION OF DRAWINGS

FIG. 1. Illustrates topical horizontal view of claimed apparatus; illustrating plane with macro scale upright. (numbers on scale not shown for simplification reasons).

FIG. 2. Illustrates Topical horizontal view of claimed apparatus, illustrating plane with micro scale upright. (numbers on scale not shown for simplification reasons).

FIG. 3. Illustrates front view of claimed apparatus, identical to posterior view.

FIG. 4. Illustrates posterior view of claimed apparatus, identical to front view.

FIG. 5. Illustrates left side view of claimed apparatus, identical to right side view.

FIG. 6. Illustrates right side View of claimed apparatus, identical to left side view.

FIG. 7. Illustrates frontal view of claimed apparatus and claimed method of verifying/establishing symmetrical accuracy of the parietal hair line.

FIG. 8. Illustrates frontal view of claimed apparatus and claimed method of verifying/establishing symmetrical accuracy of the goatee hair line.

FIG. 9. Illustrates frontal view of claimed apparatus and claimed method of verifying/establishing symmetrical of sideburns.

FIG. 10. Illustrates frontal view of claimed apparatus and claimed method of verifying/establishing symmetrical accuracy of the temporal hair line (hair line semi-circling the temples)

FIG. 11. Illustrates frontal view of claimed apparatus and claimed method of verifying/establishing symmetrical accuracy of mustache.

FIG. 12. Illustrates frontal view of claimed apparatus and claimed method of verifying/establishing symmetry of the neck hair line.

FIG. 13. Illustrates frontal view of claimed apparatus and claimed method of verifying symmetrical accuracy of symmetrical hair art designs.

FIG. 14. Illustrates rear profile view of practitioner verifying symmetrical accuracy of parietal hair line on patron, using claimed apparatus.

FIG. 15. Illustrates rear profile view of practitioner, using claimed apparatus establishing patron's parietal hair line for symmetrical accuracy.

FIG. 16. Same view as FIG. 15, without arrows, (Front page view).

### DETAILED DESCRIPTION OF DRAWING

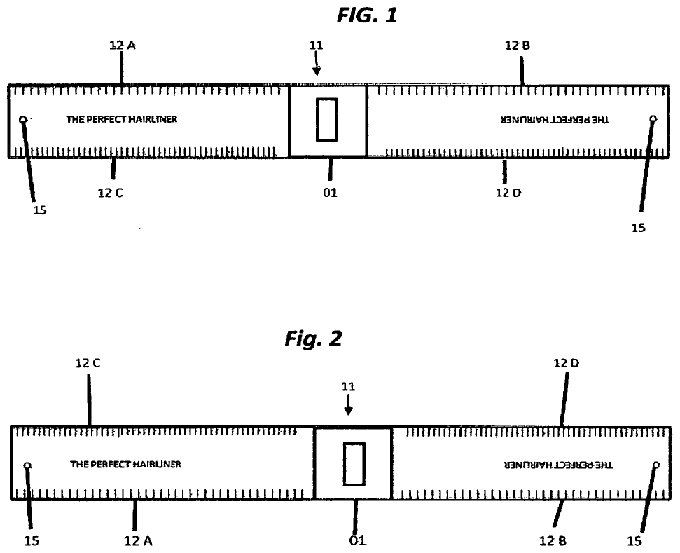

FIG. 1. Illustrates topical view of claimed apparatus (11); comprising a point of origin gauge (01) which divides the entire liner (11) into two equally scaled number lines; macro scaled plane represented by (12a. 12b); micro scaled plane represented by (12c, 12d); hanging holes (15) for convenient storage, such as hook on barber station. {centimeter scale upright}.

FIG. 2, illustrates topical view of claimed apparatus (11); comprising a point of origin gauge (01) which divides the entire apparatus (11) into two equally scaled number lines; (12c, 12d) represent micro scaled plane; (12a, 12c) represent macro scaled plane; hanging holes (15) for convenient storage such as hook on barber station. (millimeter scale upright).

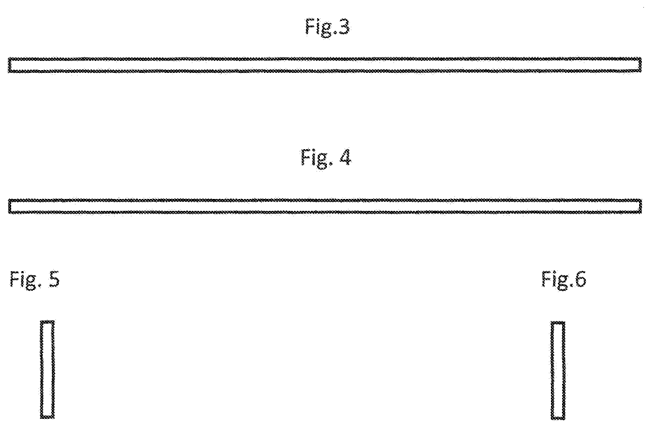

FIG. 3. Illustrates elevated frontal view of claimed apparatus, identical to rear view.

FIG. 4. Illustrates elevated posterior view of claimed apparatus, identical to frontal view.

FIG. 5. Illustrates elevated left-side view of apparatus, identical to right-side view.

FIG. 6. Illustrates elevated right-side view of apparatus, identical to left-side view.

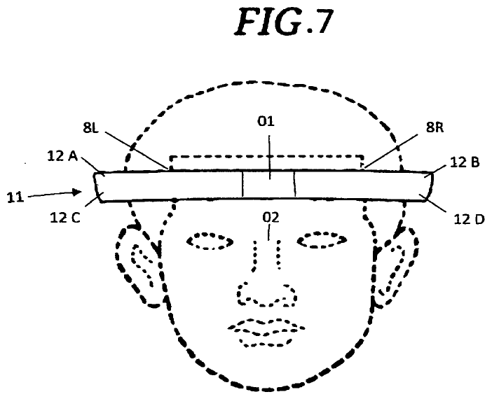

FIG. 7. Illustrates claimed apparatus (11) and claimed method of verifying and establishing symmetry of the parietal hair line (8L, 8R); illustrates Point of Origin Gauge (01) aligned with upper Divine centered nasal bone (02); illustrates claimed apparatus (11) flexed on desired points of parietal hair line (8L, 8R) to be verified or established for symmetrical accuracy; illustrates symmetrical accuracy of parietal hairline verified/established (12a equaling 12b or 12c equaling 12d) depending on which scale is being used. (Drawings and claims will simplify further).

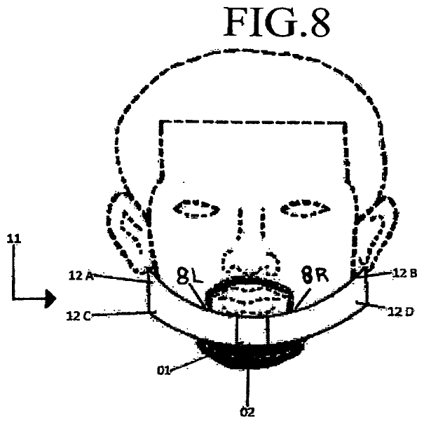

FIG. 8. Illustrates specially designed hair liner apparatus (11) and method of verifying and establishing symmetry of goatee hair line (8L, 8R); illustrates Point of origin gauge (01) centered with the mandibular symphysis bone (02); illustrates claimed apparatus (11) laying flush on desired points of hair line (8L, 8R); illustrates increments on the left side (12a or 12c) of P.O gauge (11) equaling the increments on the right-side (12b or 12d) of P.O gauge (11); illustrates verified/established symmetrical accuracy for goatee. (Drawings and claims will simplify further).

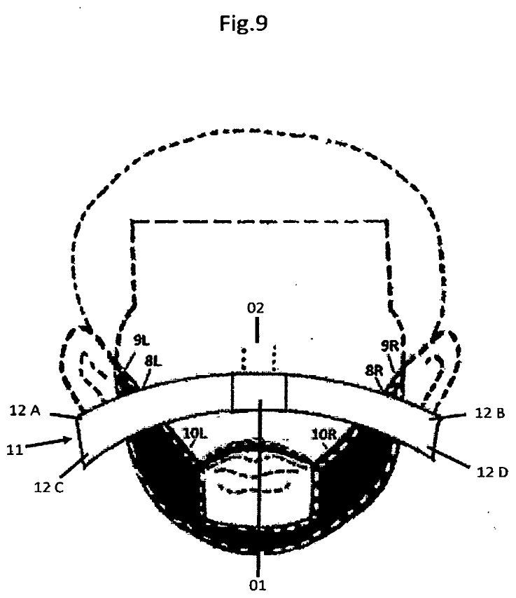

FIG. 9. Illustrates claimed apparatus (11) and claimed method of establishing accurate symmetrical sideburns (8L, 8R/9L, 9R/10L, 10R); illustrates point of origin gauge (01) centered on different levels of midpoint bones (02); illustrates claimed apparatus flexed (11) on left and right side of newly discovered points of side burn hair line to be established (8L, 8R/9L, 9R/10L, 10R).

Also illustrates claimed apparatus (11) and claimed method of verifying symmetrical accuracy of side burns (8L, 8R/9L, 9R/10L, 10R); illustrates Point of Origin gauge centered (01) with the Divine centered nasal bone (02), illustrates claimed apparatus (11) flexed on desired points of side burn hair line to be verified (8L, 8R/9L,9R/10L, 10R). Illustrates increments on the left side (12a or 12c) of P.O gauge (11) equaling the amount of increments on the right side (12b or 12d) of Point of origin gauge (01). (Drawings and claims will simplify further).

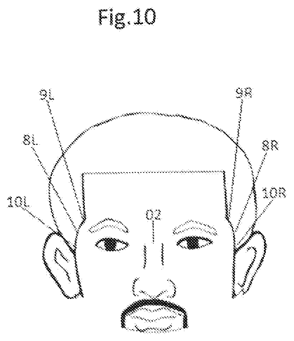

FIG. 10. Illustrates temporal hair line (8L, 8R/9L, 9R/10L, 10R) and claimed method of establishing temporal hair line symmetry; illustrates identified control points (8L, 8R); illustrates identified second pair of points (9L, 9R), illustrates third pair of points (10L, 10R). Apparatus not shown for better clarity.

Also illustrates claimed method and claimed apparatus verifying symmetrical accuracy of the temporal hair line (8L, 8R/9L, 9R/10L, 10R); illustrates Point of origin gauge (01) centered with the Divine centered nasal bone (02), illustrates claimed apparatus (11) flexed on temporal hair line being tested for accuracy (8L, 8R/9L, 9R/10L, 10R); illustrates the amount of increment deviations on left side (12a or 12c) of point of origin gauge (01) matching the amount of increments on the right side (12b or 12d) of the point of origin gauge (01), thus illustrates verified symmetrical accuracy for temporal hair line.

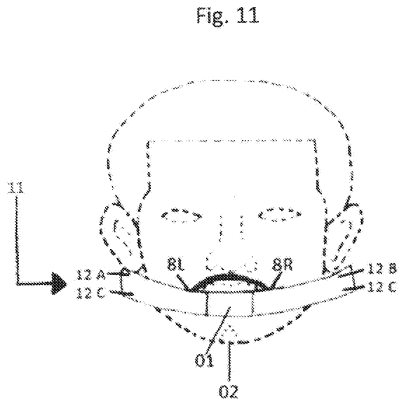

FIG. 11. Illustrates claimed apparatus (11) and claimed method of verifying/establishing symmetrical accuracy of mustache (8L, 8R); illustrates Point of origin gauge (01) centered with Divine centered mandibular bone (02), illustrates the amount of deviations on the left side (12a or 12c) of Point of Origin gauge (01) equaling the amount of deviations on the right side (12b or 12d) of Point of origin gauge (01). Thus, illustrating that symmetrical accuracy is verified/established.

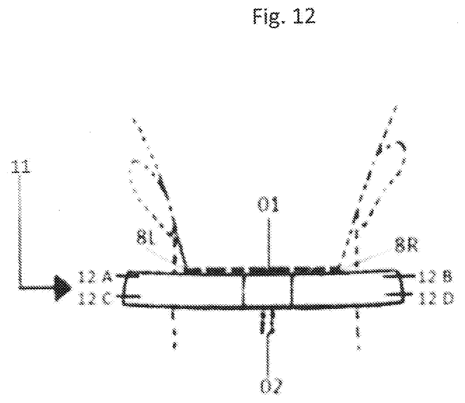

FIG. 12. Illustrates claimed apparatus (11) and claimed method of verifying and establishing neck hair line symmetry (8L, 8R) illustrates Point of Origin Gauge (01) centered with Divine centered spinal cord (line of symmetry) (02;) illustrates claimed apparatus (11) flexed on neck hair line (8L, 8R) being verified/established; Illustrates the amount of increments on the left side (12a or 12c) of point of origin gauge (11) equaling the amount of increments on the right side (12b or 12d) of Point of Origin gauge (11). Thus, illustrating that symmetry is verified/established.

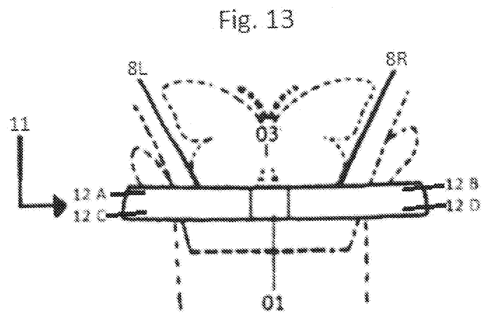

FIG. 13. Illustrates claimed apparatus (11) and claimed method of verifying symmetry of hair art designs (8L, 8R) illustrates Point of Origin Gauge (01) centered with midpoint of symmetrical hair art designs (03); illustrates increments to the left (12a or 12c) of the Point of Origin Gauge (01) equaling the amount of increments to the right side (12b or 12d) of the point of origin gauge (01); Thus illustrating, symmetrical hair art design is verified.

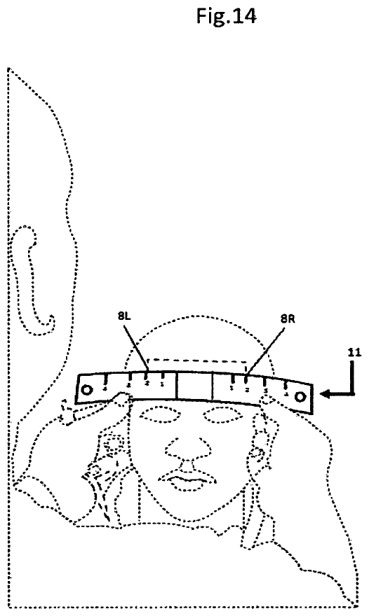

FIG. 14. illustrates practitioner; claimed apparatus (11) and claimed method verifying symmetrical accuracy of patron's parietal hair line (8L, 8R).

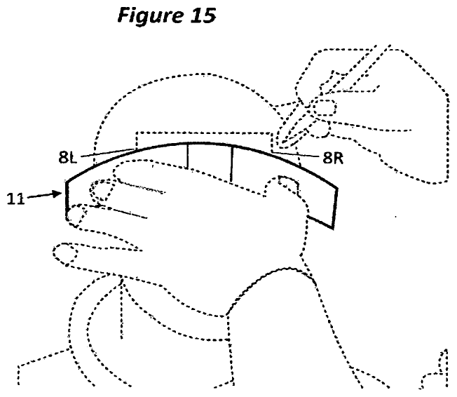

FIG. 15. Illustrates practitioner; claimed apparatus (11) and claimed method establishing symmetry of patron's parietal hair line (8L, 8R), before shaping/servicing with tool of choice.

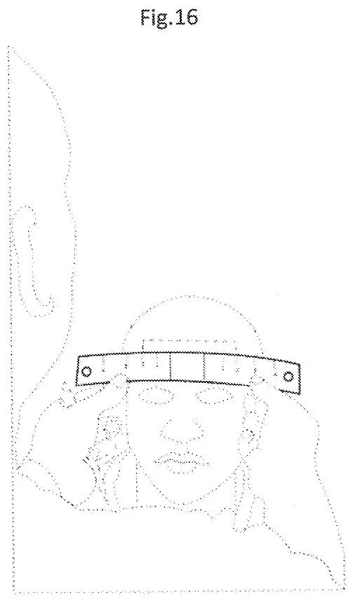

FIG. 16. Illustrates same as FIG. 15, without arrows (front page view).

1. A flexible, break resistant, contouring, symmetrical hair liner apparatus being Rectangular in shape, comprising:
a) a point of origin gauge;
b) a plane with symmetrical macro scale;
c) a plane with symmetrical micro scale;
d) hanging holes.
wherein said point of origin gauge is in center of said apparatus, extending from one horizontal plane to the other;
wherein said horizontal plane numerically incremented with a symmetrical measuring indicium on left and right side of said point of origin gauge extending outwardly;
wherein the other said horizontal plane numerically incremented with a smaller symmetrical measuring indicium on left and right side of point of origin gauge extending outwardly for more precision;
wherein said apparatus being small enough to fit in barber sanitation jar; long enough to simultaneously contour to both sides of face, forehead, neck or scalp, without practitioner having to transition oneself, apparatus or patron;
wherein said apparatus being formed of a flexible material.

2. Method verifying symmetry of a hair line after service is rendered, comprising:
a) providing apparatus of claim 1;
b) choosing either the macro scaled plane or the micro scaled plane;
c) centering said point of origin gauge over proper level of appropriate Divine midpoint bone (line of symmetry);
d) flexing the left and right side of said apparatus until it touches desired portions of hair line to be verified;
e) reading numerical increments that touch hair line to be verified;
f) verifying symmetry if numerical increments that touch hair line on both sides of point of origin gauge are the same, verifying inaccuracy if otherwise.

3. Method verifying symmetry of a curved hair line after service is rendered, comprising:
a) providing apparatus of claim 1;
b) Identifying first pair of points at deepest indentation of curved hair line (control points);
c) Choosing the macro numbered scaled plane or the micro numbered scaled plane;
d) holding said apparatus horizontally;
e) centering said point of origin gauge over proper level of appropriate Divine midpoint bone (line of symmetry);
f) flexing the left and right side of said apparatus until it touches desired portion of hair line to be verified;
g) reading numerical increments that touch hair line to be verified;
h) verifying symmetrical accuracy if numerical increments that touch hair line on both sides of said point of origin gauge are the same, verifying inaccuracy if otherwise;
i) identifying second pair of points being above control points;
j) using same scale;
k) repeat steps d)-h);
l) identifying third pair of points being below control points;
m) using same scale;
n) repeat steps d)-g);
o) verifying symmetrical accuracy if numerical increments that touch hair line on both sides of said point of origin gauge are the same; thus, verifying symmetrical accuracy or inaccuracy for the entire curved hair line.

4. Method establishing symmetry of a hair line before rendering service, comprising:
a) Providing apparatus of claim 1;
b) Choosing macro numbered scaled plane or the micro numbered scaled plane;
c) holding said apparatus horizontally;
d) centering said point of origin gauge over proper level of appropriate Divine midpoint bone (line of symmetry);
e) using one hand, simultaneously flex the left and right side of said apparatus until it touches desired portion of hair line to be established;
f) reading numerical increments that touch hair line to be established;
g) using other hand, dot desired portion of hair line to be established with eyeliner pencil before service is rendered.

5. Method establishing symmetrical range for symmetrical hair art designs before service is rendered, comprising:
a) Providing apparatus of claim 1;
b) choosing macro numbered scaled plane or the micro numbered scaled plane;
c) holding said apparatus horizontally;
d) centering said point of origin gauge with desired midpoint of symmetrical hair art design (line of symmetry);
e) flexing the left and right side of said apparatus until it touches desired range of symmetrical hair art design to be established;
f) reading numerical increments that touch desired range of symmetrical hair art design to be established;
g) dotting points where numerical increments touch desired range to be established with eyeliner pencil. Thus, establishing symmetrical range for symmetrical hair art design.

6. Method establishing symmetrical accuracy of a curved hair line, before service is rendered, comprising:
a) providing apparatus of claim 1;
b) identifying first pair of points at deepest Indentation of curved hair line (control points);
c) Choosing the macro numbered scaled plane or the micro numbered scaled plane;
d) holding said apparatus horizontally;
e) centering said point of origin gauge with proper level of appropriate midpoint bone (line of symmetry);
f) using one hand, simultaneously flex the left and right side of said apparatus until it touches desired portion of hair line to be established;
g) using other hand, dot these points with eyeliner pencil;
h) identifying second pair of points being above control points;
i) using same scale;
j) repeat steps d)-g);
k) identifying third pair of points being below control points;
l) repeat steps d)-g);
m) thus, establishing symmetry of entire curved hair line before service is rendered.

7. Method producing symmetrical hair lines on face, forehead and neck, comprising:
a) Providing apparatus of claim 1;
b) Follow steps b)-g) of claim 4;
c) using dots as a guide and tool of choice to shape/form hairline accordingly.

8. Method producing symmetrical range for symmetrical hair art designs, comprising:
a) Providing apparatus of claim 1;
b) Follow steps b)-g) of claim 5;
c) use dots as a guide and tool of choice to shape/form hair art accordingly;

9. Method producing symmetry for all hair lines containing a curve, comprising:
a) Providing apparatus of claim 1;
b) Follow steps b)-m) of claim 6;
c) using dots as a guide and tool of choice to begin shaping/forming curved hair line accordingly.
